(19) United States
(12) Patent Application Publication
(10) Pub. No.: US 2026/0051297 A1
(43) Pub. Date: Feb. 19, 2026

(54) GATE DRIVER AND DISPLAY DEVICE INCLUDING THE SAME

(71) Applicant: LG DISPLAY CO., LTD., Seoul (KR)

(72) Inventors: Min Jae JEONG, Paju-si (KR); Ki Taeg SHIN, Paju-si (KR); Ji Hoon PARK, Paju-si (KR)

(73) Assignee: LG DISPLAY CO., LTD., Seoul (KR)

(21) Appl. No.: 19/096,133

(22) Filed: Mar. 31, 2025

(30) Foreign Application Priority Data
Aug. 13, 2024 (KR) 10-2024-0107960

(51) Int. Cl. G09G 3/3266; G09G 3/32; G09G 3/3233

(52) U.S. Cl. CPC G09G 3/3266; G09G 3/3233; G09G 3/32; G09G 2300/0819; G09G 2300/0842; G09G 2300/0861; G09G 2310/0286; G09G 2310/04; G09G 2310/08; G09G 2330/021; G09G 2340/0435

(57) ABSTRACT

In one or more examples, a gate driver includes signal transmission circuits dependently connected via carry lines. Each signal transmission circuit (i) is connected to a respective carry line to which a respective carry signal is applied from a respective previous signal transmission circuit and (ii) outputs a respective gate signal in response to a respective clock signal. An (n)th signal transmission circuit includes an output circuit for receiving an (n−1)th carry signal from a previous signal transmission circuit, an (n+1)th carry signal from a next signal transmission circuit, and a clock signal, and to charge or discharge a first control node and a second control node to output a gate signal, and a selection circuit for selectively charging the first control node so that the gate signal is output from the output circuit connected to a predetermined gate line. A display device including the gate driver is also disclosed.

### CROSS-REFERENCE TO RELATED APPLICATION

This application claims the benefit of and priority to Korean Patent Application No. 10-2024-0107960, filed Aug. 13, 2024, the entire contents of which are incorporated herein by reference for all purposes.

### BACKGROUND

### 1. Technical Field

The present disclosure relates to a gate driver and a display device including the same.

### 2. Description of the Related Art

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself, and has advantages in that a response speed is fast and luminous efficiency, luminance, and a viewing angle are large.

In organic light-emitting display devices, organic light-emitting diodes (referred to as “OLEDs”) are formed in each of pixels. These organic light display devices not only respond quickly and have excellent light-emitting efficiency, luminance, and viewing angle, but also have excellent contrast ratio and color reproduction rate because they can express black tones as complete black.

Some of display devices, for example, a liquid crystal display device or an organic light emitting display device includes a display panel including a plurality of sub-pixels, a driver outputting a driving signal for driving the display panel, a power supply generating power to be supplied to the display panel or the driver, and the like. The driver includes a gate driver that supplies a gate signal, such as a scan signal and emission signal to the display panel, and a data driver that supplies a data signal to the display panel.

The description of the related art should not be assumed to be prior art merely because it is mentioned in or associated with this section. The description of the related art includes information that describes one or more aspects of the subject technology, and the description in this section does not limit the invention.

### SUMMARY

A user may play two or more content videos on a single screen of the display device or execute two or more applications to play videos from different applications on the screen. In such a multitasking environment, the pixels of the display device are driven at a single frame frequency.

In a typical gate driver of the display device, gate signals are output sequentially. In the gate driver, it is impossible to drive different regions of the panel at different frequencies because there is no separate structure capable of blocking the output in the middle of a frame.

One or more aspects of the present disclosure are directed to solving problems due to limitations and disadvantages of the related art, including the above-described problems.

One or more aspects of the present disclosure provide a gate driver capable of driving different regions at different frequencies and a display device including the same.

It should be noted that aspects of the present disclosure are not limited to the above-described aspects, and other aspects of the present disclosure will be apparent to those skilled in the art from the following descriptions.

A gate driver according to embodiments of the present disclosure may include a plurality of signal transmission circuits that are dependently connected via carry lines, wherein each of the plurality of signal transmission circuits is connected to a respective carry line to which a respective carry signal is applied from a respective previous signal transmission circuit, and wherein each of the plurality of signal transmission circuits is configured to output a respective gate signal in response to a respective clock signal; wherein an (n)th signal transmission circuit, where n is a positive integer, includes: an output circuit configured to receive an (n−1)th carry signal from a previous signal transmission circuit, an (n+1)th carry signal from a next signal transmission circuit, and a clock signal, and to charge or discharge a first control node and a second control node to output a gate signal; and a selection circuit configured to selectively charge the first control node so that the gate signal is output from the output circuit connected to a predetermined gate line among predetermined gate lines.

A display device according to embodiments of the present disclosure may include a pixel array in which a plurality of data lines, a plurality of gate lines, and a plurality of pixel circuits are arranged; a data driver configured to output data voltages to the plurality of data lines; a gate driver configured to output gate signals to the plurality of gate lines; and a timing controller configured to control a timing operation of the data driver and the gate driver, wherein the gate driver comprises: a plurality of signal transmission circuits that are dependently connected via carry lines, wherein each of the plurality of signal transmission circuits is connected to a respective carry line to which a respective carry signal is applied from a respective previous signal transmission circuit, and wherein each of the plurality of signal transmission circuits is configured to output a respective gate signal in response to a respective clock signal; and wherein an (n)th signal transmission circuit, where n is a positive integer, includes: an output circuit configured to receive an (n−1)th carry signal from a previous signal transmission circuit, an (n+1)th carry signal from a next signal transmission circuit, and a clock signal, and to charge or discharge a first control node and a second control node to output a gate signal; and a selection circuit configured to selectively charge the first control node so that the gate signal is output from the output circuit connected to a predetermined gate line among predetermined gate lines.

One or more aspects of the present disclosure may enable driving at different frequencies for each of a plurality of regions by configuring each signal transmission circuit constituting the gate driver with a selection circuit and an output circuit, and by allowing the selection circuit to select the output circuit for outputting gate signals.

One or more aspects of the present disclosure may improve the refresh rate by scanning only the regions where images are displayed.

One or more aspects of the present disclosure may enable low-power driving since low-speed driving may be possible depending on the region.

The effects of the present specification are not limited to the above-mentioned effects, and other effects that are not mentioned will be apparently understood by those skilled in the art from the following description and the appended claims.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a block diagram showing a display device according to an embodiment of the present disclosure;

FIG. 2 is a diagram showing a pixel circuit according to an embodiment of the present disclosure;

FIG. 3 is a diagram showing the driving timing of the pixel circuit illustrated in FIG. 2;

FIG. 4 is a diagram showing a shift register of the gate driver according to the embodiment;

FIG. 5 is a diagram showing a normal driving waveform of the gate driver illustrated in FIG. 4;

FIGS. 6A to 6B are diagrams showing the configuration of the selection circuit illustrated in FIG. 4;

FIG. 7 is a diagram showing a gate driver according to an embodiment of the present disclosure;

FIG. 8 is a diagram for explaining an example in which different regions are driven at different frequencies;

FIG. 9 is a diagram showing a selective driving waveform of the gate driver illustrated in FIG. 7;

FIGS. 10A to 10D are diagrams for explaining the operating principle of the selection circuit according to the embodiment;

FIG. 11 is a diagram for explaining the modulation principle of the clock signal illustrated in FIG. 9;

FIG. 12 is a diagram for explaining an example of scanning only selected regions where images are displayed;

FIG. 13 is a diagram showing a selective driving waveform of the gate driver illustrated in FIG. 12; and

FIGS. 14 to 16 are diagrams for explaining the principle of improving the refresh rate.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

Advantages and features of the present specification and methods of achieving them will become apparent with reference to preferable embodiments, which are described in detail, in conjunction with the accompanying drawings. However, the present specification is not limited to the embodiments to be described below and may be implemented in different forms, the embodiments are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the embodiments of the present disclosure are only examples, the present disclosure is not limited to the illustrated items. The same reference numerals indicate the same components throughout the specification. Further, in describing the present disclosure, when it is determined that a detailed description of related known technology may unnecessarily obscure the gist of the present disclosure, the detailed description thereof will be omitted.

When ‘including,’ ‘having,’ ‘consisting,’ and the like mentioned in the present specification are used, other parts may be added unless ‘only’ is used. A case in which a component is expressed in a singular form includes a plural form unless explicitly stated otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, the terms “between” and “among” may be used interchangeably simply for convenience unless stated otherwise. In one or more aspects, the phrases “each other” and “one another” may be used interchangeably simply for convenience unless stated otherwise. In one or more aspects, unless stated otherwise, the term “nth” may refer to “nnd” (e.g., 2nd where n is 2), or “nrd” (e.g., 3rd where n is 3), and n may be a natural number or a whole number.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” or “nearly the same” may indicate a degree of being considered as being equivalent to each other taking into account minute differences due to errors in the manufacturing process.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to,’ and the like, one or more other parts may be located between the two parts unless ‘immediately’ or ‘directly’ is used.

Although first, second, and the like are used to describe various components, these components are not limited by these terms. These terms are only used to distinguish one component from another. Accordingly, a first component, which is mentioned, below may also be a second component within the technical spirit of the present disclosure.

The same reference numerals may refer to substantially the same elements throughout the present disclosure.

The following embodiments can be partially or entirely bonded to or combined with each other and can be linked and operated in technically various ways. The embodiments can be carried out independently of or in association with each other.

In the following description, various embodiments of the present disclosure will be described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

In description of flow of a signal, for example, when a signal is provided from a node A to a node B, this may include a case where the signal is transferred from the node A to the node B via one or more nodes unless a phrase such as “immediately transferred,” “directly transferred” or the like is used.

In a display device of the present disclosure, the pixel circuit and the gate driving circuit may include a plurality of transistors. Transistors may be implemented as oxide thin film transistors (oxide TFTs) including an oxide semiconductor, low temperature polysilicon (LTPS) TFTs including low temperature polysilicon, or the like.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage may be a gate high voltage, and a gate-off voltage may be a gate low voltage. In the case of the p-channel transistor, a gate-on voltage may be a gate low voltage, and a gate-off voltage may be a gate high voltage.

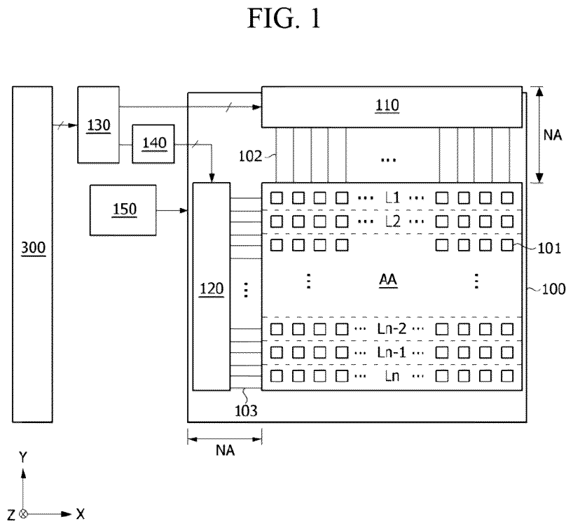

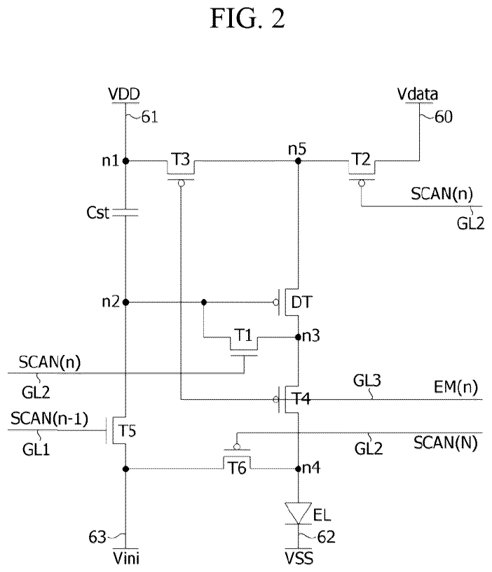

FIG. 1 is a block diagram showing a display device according to an embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 may be, but not limited to, a panel having a rectangular structure with a length in the X-axis direction, a width in the Y-axis direction, and a thickness in the Z-axis direction. For example, the display panel 100 may be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels arranged in a matrix form. The display panel 100 may further include power lines commonly connected to the pixels. The power lines may be commonly connected to pixel circuits to supply a voltage required for driving pixels 101 to the pixels 101.

Each of the pixels 101 may be divided into a red sub-pixel, a green sub-pixel, and a blue sub-pixel for color implementation. Each pixel may further include a white sub-pixel. Each sub-pixel includes a pixel circuit for driving a light emitting element. The light emitting element may include an OLED or an inorganic light emitting diode (LED). Each pixel circuit is connected to the data lines, the gate lines, and the power lines. In the following description, a pixel may be interpreted as a sub-pixel.

The pixels may be arranged as real color pixels and pentile pixels. A pentile pixel may realize a higher resolution than a real color pixel by driving two sub-pixels with different colors as one pixel 101 and using a preset pixel rendering algorithm. This pixel rendering algorithm may compensate for insufficient color representation in each pixel with the color of light emitted from adjacent pixels.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 may be implemented with a non-transmissive display panel or a transmissive display panel. The transmissive display panel may be applied to a transparent display device in which an image is displayed on the screen and a real object in the background is visible. The display panel 100 may be made of a flexible display panel.

The power supply 150 receives an input voltage applied from the host system 300 and outputs a voltage needed to drive the pixels 101 of the display panel 100 and the display panel driving circuit. To this end, the power supply 150 may include a direct current to direct current converter (DC-DC converter). The DC-DC converter may include a charge pump, a regulator, a buck converter, a boost converter, and the like. The power supply 150 may output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage may be supplied to the level shifter 140 and the gate driver 120. Voltages such as pixel driving voltage, cathode voltage, and reference voltage may be supplied to the pixels 101 through the power lines commonly connected to the pixels 101.

The power supply 150 may further include a gamma voltage generator. The gamma voltage generator receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages. The gamma voltage generator may be implemented with a programmable gamma circuit that may adjust the voltage of each of the gamma reference voltages according to digital data. The timing controller 130, the host system 300, or a separate external device may update digital data stored in a register of the programmable gamma circuit through a communication interface.

The display panel driving circuit writes pixel data of the input image to the pixels 101 of the display panel 100 under the control of the timing controller 130. The display panel driving circuit includes a data driver 110 and a gate driver 120.

The display panel driving circuit may further include a touch sensor driver for driving touch sensors. The touch sensor driver is not shown in FIG. 1. The data driver 110 and the touch sensor driver may be integrated into one source drive IC.

The data driver 110 receives pixel data of the input image as a digital signal from the timing controller 130 and outputs a data voltage. The data driver 110 may receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data may include mode selection data for selecting first mode and second mode. The DAC converts the pixel data into a gamma compensation voltage and outputs a data voltage of the pixel data.

The gate driver 120 may be formed on the display panel 100 together with the circuit elements and wiring lines of the display area AA. The gate driver 120 may be disposed in at least one of left and right non-display areas NA outside the display area AA in the display panel 100 or at least a part thereof may be disposed within the display area AA.

The gate driver 120 sequentially outputs pulses of the gate signals to the gate lines 103 under the control of the timing controller 130. The gate driver 120 may sequentially supply the gate signals to the gate lines 103 by shifting the pulses of the gate signals using shift registers. When a plurality of gate signals are applied to each pixel, the gate driver 120 may include a plurality of shift registers. The gate signal may include a scan signal being input to the pixel circuit through a plurality of gate lines, and an emission signal (or EM signal).

The timing controller 130 receives digital video data of an input image and a timing signal synchronized with this data from the host system 300. The timing signal may include a vertical synchronization signal Vsync, a horizontal synchronization signal Hsync, and a data enable signal DE. Since the vertical period and horizontal period may be known by counting the data enable signal DE, the vertical synchronization signal Vsync and the horizontal synchronization signal Hsync may be omitted. The horizontal synchronization signal Hsync and the data enable signal DE have a periodicity of 1 horizontal period (1H).

The timing controller 130 may control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 may synchronize the data driver 110 and the gate driver 120 by controlling the operation timing of the display panel driving circuit.

The gate timing control signal output from the timing controller 130 may be input to the shift register of the gate driver 120 through the level shifter 140. The level shifter 140 may convert a voltage of the gate timing control signal received from the timing controller 130 to a swing width between the gate-on voltage and the gate-off voltage and supply it to the gate driver 120.

The timing controller 130 may analyze the input image for each frame and generate a control signal for selectively outputting gate signals according to the analysis result. The generated control signal may be provided to the shift register of the gate driver 120 through the level shifter 140. Such control signals may include a selection signal SLM, a start signal SVS, and a reset signal SRS, but are not limited thereto.

The timing controller 130 may provide a modulated clock signal along with the control signal.

The host system 300 may include a main board of one of a television system, a set-top box, a navigation system, a personal computer (PC), a vehicle system, a mobile terminal, and a wearable terminal. The host system 300 may scale an image signal from a video source according to the resolution of the display panel 100, and may transmit it to the timing controller 130 together with the timing signals.

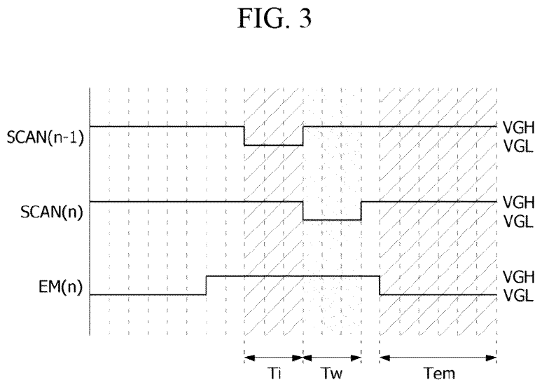

FIG. 2 is a diagram showing a pixel circuit according to an embodiment of the present disclosure, and FIG. 3 is a diagram showing the driving timing of the pixel circuit illustrated in FIG. 2.

Referring to FIGS. 2 and 3, the pixel circuit according to an embodiment of the present disclosure includes a light-emitting element EL, a driving element DT that supplies current to the light-emitting element EL, a plurality of switching elements T1, T2, T3, T4, T5, and T6 that switch the current path connected to the driving element DT, and a capacitor Cst that stores the gate-to-source voltage of the driving element DT. The driving element DT and the switching elements T1, T2, T3, T4, T5, and T6 may be implemented as P-channel oxide TFTs.

The gate signals applied to the pixel circuit include an (n)th scan signal SCAN(N), an (n−1)th scan signal SCAN(N−1), and an EM signal EM(N). Here, N is a natural number.

The capacitor Cst is connected between a first node n1 and a second node n2. VDD is supplied to the pixel circuit through the VDD wire 61. The first node n1 is connected to the VDD wire 61, a first electrode of the third switching element T3, and a first electrode of the capacitor Cst. The second node n2 is connected to a second electrode of the capacitor Cst, a gate electrode of the driving element DT, a first electrode of the first switching element T1, and a first electrode of the fifth switching element T5.

The first switching element T1 is turned on according to the gate-on voltage VGL of the (n)th scan signal SCAN(N), connecting the gate electrode and the second electrode of the driving element DT. The first switching element T1 includes a gate electrode connected to a second scan line GL2, a first electrode connected to the second node n2, and a second electrode connected to a third node n3. The (n)th scan signal SCAN(N) is supplied to the pixels through the second scan line GL2. The third node n3 is connected to a second electrode of the driving element DT, a second electrode of the first switching element T1, and a first electrode of the fourth switching element T4.

The second switching element T2 is turned on according to the gate-on voltage VGL of the (n)th scan signal SCAN(N), applying the data voltage Vdata to the first electrode of the driving element DT. The second switching element T2 includes a gate electrode connected to the second scan line GL2, a first electrode connected to a fifth node n5, and a second electrode connected to the data line 60. The fifth node n5 is connected to a first electrode of the driving element DT, a first electrode of the second switching element T2, and a second electrode of the third switching element T3.

The third switching element T3 supplies the pixel driving voltage VDD to the first electrode of the driving element DT in response to the EM signal EM(N). The third switching element T3 includes a gate electrode connected to the EM line GL3, a first electrode connected to the VDD wire 61, and a second electrode connected to the fifth node n5. The EM signal EM(N) is supplied to the pixels P through the EM line GL3.

The fourth switching element T4 is turned on according to the gate-on voltage VGL of the EM signal EM(N), connecting the second electrode of the driving element DT to the anode of the light-emitting element EL. The gate electrode of the fourth switching element T4 is connected to the EM line GL3. The first electrode of the fourth switching element T4 is connected to the third node n3, and the second electrode of the fourth switching element T4 is connected to a fourth node n4. The fourth node n4 is connected to the anode electrode of the light-emitting element EL, the second electrode of the fourth switching element T4, and the second electrode of the sixth switching element T6.

The fifth switching element T5 is turned on according to the gate-on voltage VGL of the (n−1)th scan signal SCAN(N−1), connecting the second node n2 to the Vini wire 63 to initialize the capacitor Cst and the gate of the driving element DT during the initialization stage Ti. The fifth switching element T5 includes a gate electrode connected to the first scan line GL1, a first electrode connected to the second node n2, and a second electrode connected to the Vini wire 63. The (n−1)th scan signal SCAN(N−1) is supplied to the pixels through the first scan line GL1. The initialization voltage Vini is supplied to the pixels through the Vini wire 63.

The sixth switching element T6 is turned on according to the gate-on voltage VGL of the (n)th scan signal SCAN(N), connecting the Vini wire 63 to the anode of the light-emitting element EL. The sixth switching element T6 includes a gate electrode connected to the second scan line GL2, a first electrode connected to the Vini wire 63, and a second electrode connected to the fourth node n4.

The driving element DT controls the current flowing through the light-emitting element EL according to the gate-to-source voltage Vgs, thereby driving the light-emitting element EL. The driving element DT includes a gate electrode connected to the second node n2, a first electrode connected to the fifth node n5, and a second electrode connected to the third node n3.

The light-emitting element EL is connected between the fourth node n4 and the VSS wire 62. The light-emitting element EL may be implemented as an OLED. The OLED includes an organic compound layer formed between the anode and the cathode. The organic compound layer may include a hole injection layer (HIL), a hole transport layer (HTL), an emission layer (EML), an electron transport layer (ETL), and an electron injection layer (EIL), but is not limited thereto. When a voltage is applied to the anode and cathode of the OLED, holes passing through the hole transport layer (HTL) and electrons passing through the electron transport layer (ETL) move to the emission layer, forming excitons. As a result, visible light is emitted from the emission layer.

In the initialization stage Ti, the fifth switching element T5 is turned on, discharging the voltage of the second node n2 down to the initialization voltage Vini.

In the data writing stage Tw, the first switching element T1, the second switching element T2, and the sixth switching element T6 are turned on, applying the data voltage to the fifth node n5, and the voltage of the second node n2 becomes (Vdata+Vth). The threshold voltage Vth of the driving element is sensed and charged in the capacitor Cst connected to the second node n2.

In the emission stage Tem, the third switching element T3 and the fourth switching element T4 are turned on, allowing current to flow through the driving element DT to the light-emitting element EL, thereby causing the light-emitting element EL to emit light.

To drive different regions at different frequencies using such a pixel circuit, gate signals must be selectively output. That is, a gate signal should be output in an interval in which high-speed driving is performed, while the gate signal should not be output in an interval in which low-speed driving is performed, so that some regions can be operated at high speeds and others at low speeds. Since implementing low-speed driving involves preventing the output of gate signals, it may be achieved by not outputting the (n−1)th scan signal and the (n)th scan signal. For example, to prevent the voltages of the second node n2 and the third node n3 of the pixel circuit arranged in the low-speed driving region from being initialized, the first switching element T1, the second switching element T2, the fifth switching element T5, and the sixth switching element T6 are turned off.

The pixel circuit described here is merely an example and is not necessarily limited thereto.

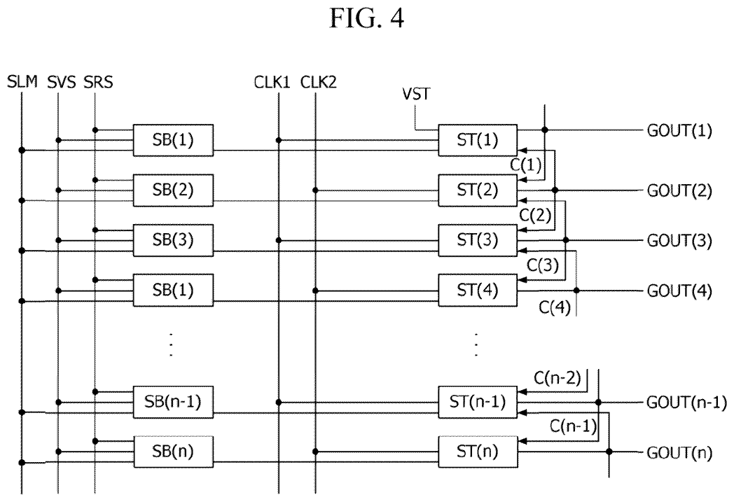

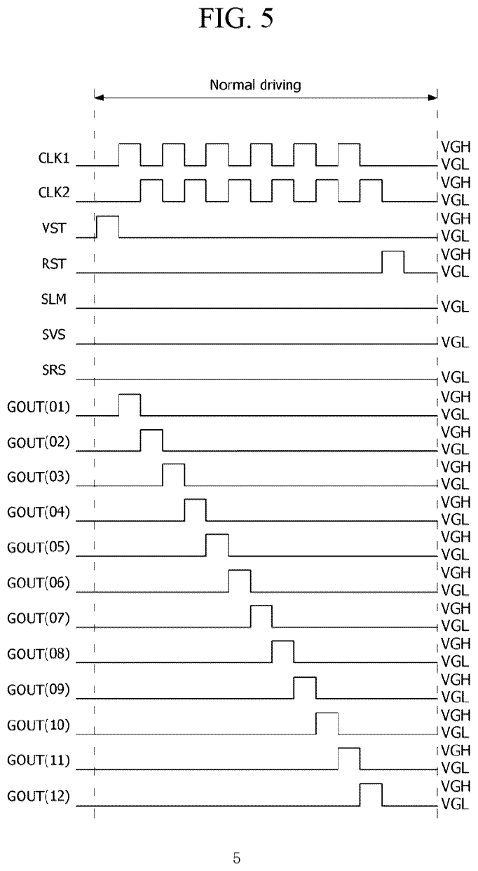

FIG. 4 is a diagram showing a shift register of the gate driver according to the embodiment, and FIG. 5 is a diagram showing a normal driving waveform of the gate driver illustrated in FIG. 4.

Referring to FIGS. 4 and 5, the gate driver according to the embodiment includes a plurality of signal transmission circuits (SB(1), ST(1)), (SB(2), ST(2)), (SB(3), ST(3)), (SB(4), ST(4)), . . . , (SB(n−1), ST(n−1)), (SB(n), ST(n)) that are connected in a dependent manner via a carry line through which a carry signal is transmitted.

In the embodiment, SB(n) may be a selection circuit for selecting a gate line to output gate signals, and ST(n) may be an output circuit for outputting the gate signals.

Each selection circuit in the signal transmission circuit SB(1), SB(2), SB(3), SB(4), . . . , SB(n−1), SB(n) may be activated according to the selection signal SLM, the start signal SVS, and the reset signal SRS, and may control the output circuits ST(1), ST(2), ST(3), ST(4), . . . , ST(n−1), ST(n) to output gate signals.

As an example, as shown in FIG. 5, during normal driving, the selection signal SLM, the start signal SVS, and the reset signal SRS are applied at a low-level voltage, activating all the selection circuits SB(1), SB(2), SB(3), SB(4), . . . , SB(n−1), SB(n). As a result, gate signals GOUT(1), GOUT(2), GOUT(3), GOUT(4), . . . , GOUT(n−1), GOUT(n) may be sequentially output from all the output circuits ST(1), ST(2), ST(3), ST(4), . . . , ST(n−1), ST(n).

In another example, during selective driving, the selection signal SLM, the start signal SVS, and the reset signal SRS are applied at a high-level voltage, activating only some of the selection circuits SB(1), SB(2), SB(3), SB(4), . . . , SB(n−1), SB(n). As a result, gate signals may be sequentially output from only some of the output circuits ST(1), ST(2), ST(3), ST(4), . . . , ST(n−1), ST(n). The operating principle of the selection circuit during selective driving will be described below.

At this time, each of the output circuits ST(1), ST(2), ST(3), ST(4), . . . , ST(n−1), ST(n) in the signal transmission circuit may sequentially output gate signals GOUT(1), GOUT(2), GOUT(3), GOUT(4), . . . , GOUT(n−1), GOUT(n) according to the timing of the clock signals CLK1 and CLK2.

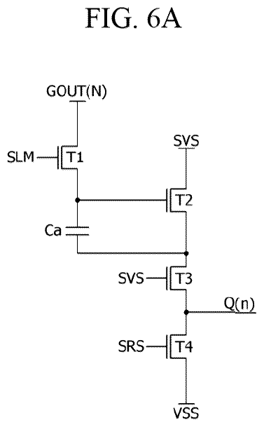

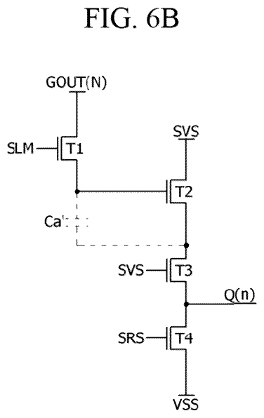

FIGS. 6A to 6B are diagrams showing the configuration of the selection circuit illustrated in FIG. 4.

Referring to FIGS. 6A and 6B, the selection circuit according to an embodiment may include a first transistor T1, a second transistor T2, a third transistor T3, a fourth transistor T4, and a first capacitor Ca. The first to fourth transistors T1 to T4 may be n-type TFTs, but are not necessarily limited thereto, and the first to fourth transistors T1 to T4 may also be p-type TFTs.

The first capacitor Ca may be used to stably maintain the charging voltage of the first node Na.

The first capacitor Ca may be designed to have a predetermined capacitance range, for example, from 0 to 10 pF. Here, the first capacitor Ca having a capacitance of 0 pF may refer to a case where the first capacitor Ca is applied as a parasitic capacitor Ca′, as shown in FIG. 6B.

When the off current of the transistor is close to zero, applying only the parasitic capacitor Ca′ may be sufficient to maintain the charging voltage of the first node Na. Here, the off current refers to the leakage current that occurs between the source electrode and the drain electrode of the transistor when the transistor is in the off state.

The capacitance of the first capacitor Ca may vary depending on the off current and the capacitance of the parasitic capacitor. That is, if the off current characteristic is poor and a parasitic capacitor with a small capacitance is formed, the capacitance of the first capacitor Ca may increase. Conversely, if the off current characteristic is good and a parasitic capacitor with a large capacitance is formed, the capacitance of the first capacitor Ca may decrease.

The selection circuit according to the embodiment serves to charge the first control node of the output circuit, allowing the output circuit to output gate signals in synchronization with the timing of the clock signal. In other words, when a carry signal is not output from the previous signal transmission circuit that is not selected, the selection circuit charges the first control node of the corresponding signal transmission circuit in place of the carry signal.

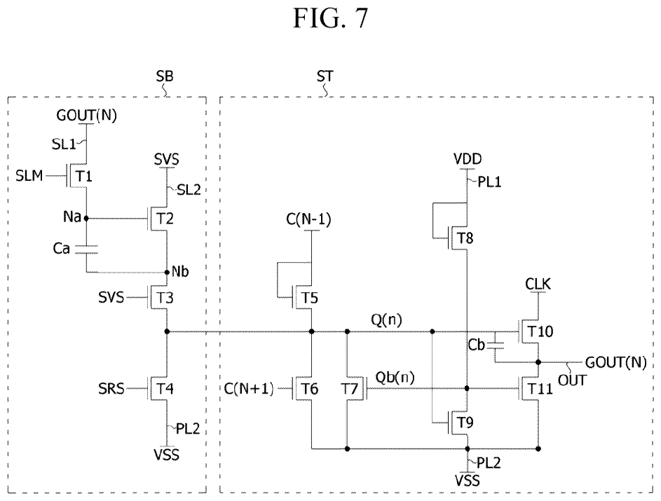

FIG. 7 is a diagram showing a gate driver according to an embodiment of the present disclosure.

Referring to FIG. 7, the gate driver according to an embodiment of the present disclosure may include a selection circuit SB for selecting a scan line from which a scan signal is output and an output circuit ST for outputting the scan signal.

The selection circuit SB may include a first transistor T1, a second transistor T2, a third transistor T3, a fourth transistor T4, and a first capacitor Ca.

The first transistor T1 is turned on by the selection signal SLM and connects the first node Na to the first signal line SL1, to which the scan signal is applied. The first transistor T1 includes a gate electrode to which the selection signal SLM is applied, a first electrode connected to the first signal line SL1, and a second electrode connected to the first node Na.

The second transistor T2 is turned on by the voltage of the first node Na and connects the second node Nb to the second signal line SL2, to which the start signal SVS is applied. The second transistor T2 includes a gate electrode connected to the first node Na, a first electrode connected to the second signal line SL2, and a second electrode connected to the second node Nb.

The third transistor T3 is turned on by the start signal SVS and connects the second node Nb to the first control node Q(n). The third transistor T3 includes a gate electrode to which the start signal SVS is applied, a first electrode connected to the second node Nb, and a second electrode connected to the first control node Q(n).

The fourth transistor T4 is turned on by the reset signal SRS and connects the first control node Q(n) to the second power line PL2, to which a low-potential voltage VSS is applied. The fourth transistor T4 includes a gate electrode to which the reset signal SRS is applied, a first electrode connected to the first control node Q(n), and a second electrode connected to the second power line PL2.

The first capacitor Ca is connected between the first node Na and the second node Nb. The first capacitor Ca may stably maintain the charging voltage of the first node Na. The first capacitor Ca may be designed to have a predetermined capacitance range, for example, from 0 to 10 pF.

The output circuit ST may include a first control node Q(n) where the output voltage is pulled up, a second control node Qb(n) where the output voltage is pulled down, a fifth transistor T5, a sixth transistor T6, a seventh transistor T7, an eighth transistor T8, a ninth transistor T9, a tenth transistor T10, an eleventh transistor T11, and a second capacitor Cb.

The fifth transistor T5 is turned on by the start signal VST or the carry signal C(N−1) transmitted from the previous signal transmission circuit and applies the carry signal C(N−1) to the first control node Q(n). The fifth transistor T5 includes a gate electrode and a first electrode to which the carry signal C(N−1) from the previous signal transmission circuit is applied, and a second electrode connected to the first control node Q(n).

The sixth transistor T6 is turned on by the reset signal RST or the carry signal C(N+1) transmitted from the next signal transmission circuit and discharges the first control node Q(n) down to the low-potential voltage VSS. The sixth transistor T6 includes a gate electrode to which the carry signal C(N+1) transmitted from the next signal transmission circuit is applied, a first electrode connected to the first control node Q(n), and a second electrode connected to the second power line PL2.

The seventh transistor T7 is turned on by the voltage of the second control node Qb(n) and discharges the first control node Q(n) down to the low-potential voltage VSS. The seventh transistor T7 includes a gate electrode connected to the second control node Qb(n), a first electrode connected to the first control node Q(n), and a second electrode connected to the second power line PL2.

The eighth transistor T8 is turned on by a high-potential voltage and connects the second control node Qb(n) to the first power line PL1, to which the high-potential voltage is applied. The eighth transistor T8 includes a gate electrode and a first electrode connected to the first power line PL1, and a second electrode connected to the second control node Qb(n).

The ninth transistor T9 is turned on by the voltage of the first control node Q(n) and discharges the second control node Qb(n) down to the low-potential voltage VSS. The ninth transistor T9 includes a gate electrode connected to the first control node Q(n), a first electrode connected to the second control node Qb(n), and a second electrode connected to the second power line PL2.

The tenth transistor T10 is turned on by the voltage of the first control node Q(n) and outputs the clock signal CLK to the output node OUT. The tenth transistor T10 includes a gate electrode connected to the first control node Q(n), a first electrode to which the clock signal CLK is applied, and a second electrode connected to the output node OUT.

The eleventh transistor T11 is turned on by the voltage of the second control node Qb(n) and outputs the low-potential voltage VSS to the output node OUT. The eleventh transistor T11 includes a gate electrode connected to the second control node Qb(n), a first electrode connected to the output node OUT, and a second electrode connected to the second power line PL2.

The second capacitor Cb is connected between the gate electrode and the source electrode of the tenth transistor T10. The second capacitor Cb may boost the first control node with the output gate signal.

The output circuit described here is merely an example and is not necessarily limited thereto.

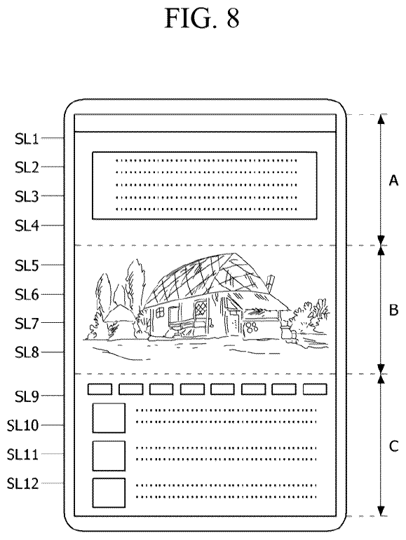

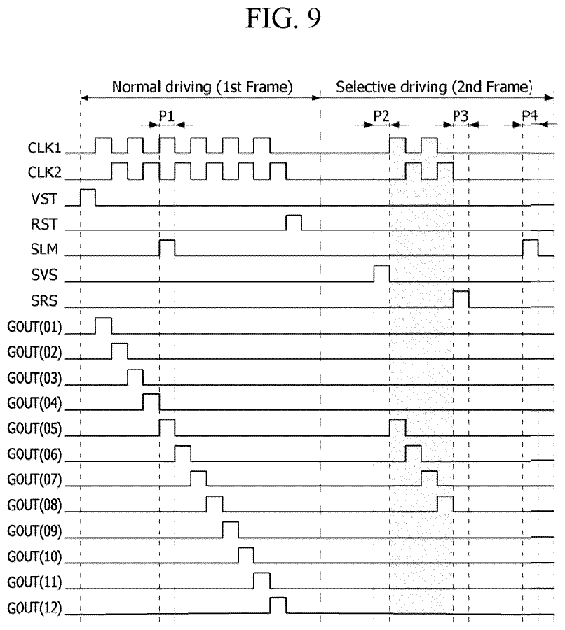

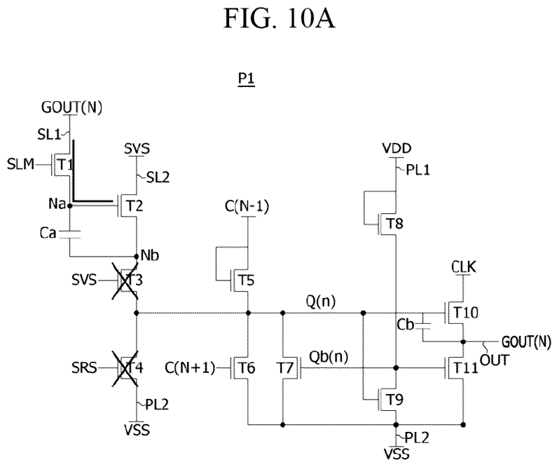

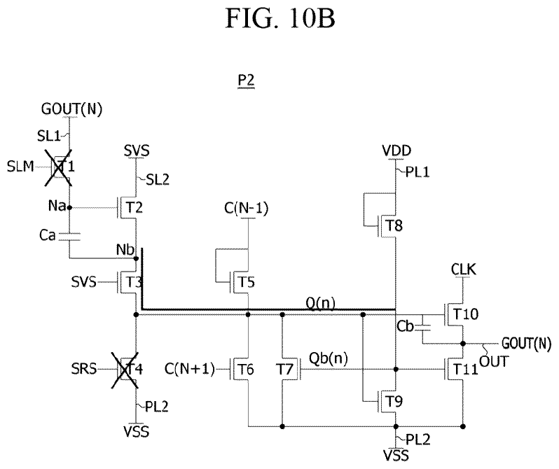

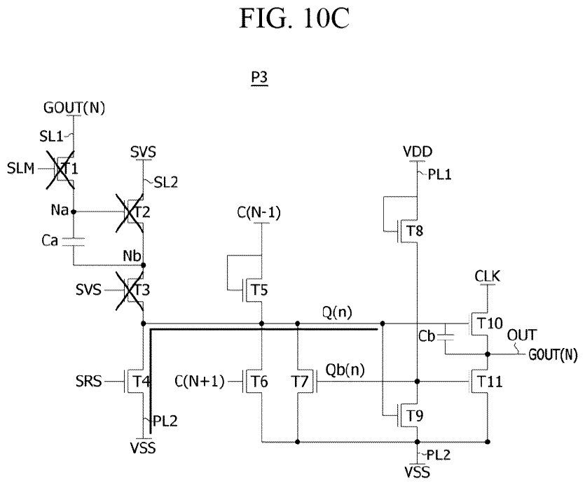

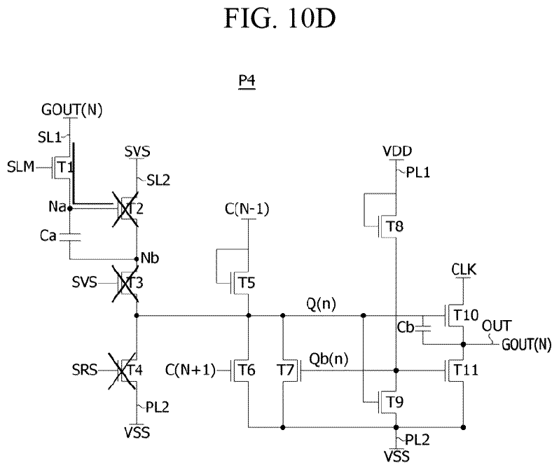

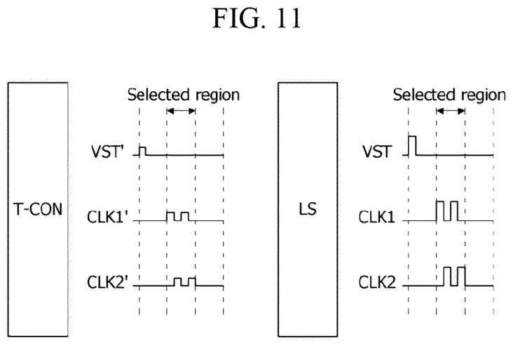

FIG. 8 is a diagram for explaining an example in which different regions are driven at different frequencies, FIG. 9 is a diagram showing a selective driving waveform of the gate driver illustrated in FIG. 7, and FIGS. 10A to 10D are diagrams for explaining the operating principle of the selection circuit according to the embodiment.

Hereinafter, an example will be described in which the fifth to eighth scan lines among the first to twelfth scan lines are selectively driven. As shown in FIG. 8, the first to fourth scan lines SL1 to SL4 of the first region A and the ninth to twelfth scan lines SL9 to SL12 of the third region C may not receive scan signals, enabling low-speed driving. Meanwhile, scan signals may be applied to the fifth to eighth scan lines SL5 to SL8 of the second region B, enabling high-speed driving.

Referring to FIGS. 8, 9, and 10A, during the first period P1 of the first frame interval for normal driving, a selection signal SLM with a high-level voltage may be applied to the gate driver connected to the fifth scan line SL5, which is the first scan line among the fifth to eighth scan lines SL5 to SL8 for selective driving.

By the high-level voltage of the selection signal SLM, the first transistor T1 is turned on, allowing the high-level voltage of the scan signal to be applied to the first node Na, thereby charging the first capacitor Ca.

At this time, since the start signal SVS and the reset signal SRS are at a low-level voltage, the third transistor T3 and the fourth transistor T4 remain in the off state.

In the embodiment, the first capacitor of the selection circuit is intended to be charged during the first frame interval, which is the previous frame interval, rather than during the second frame interval where selective driving occurs.

Referring to FIGS. 8, 9, and 10B, during the second period P2 of the second frame interval for selective driving, a start signal SVS with a high-level voltage may be applied to the gate driver connected to the fifth scan line SL5, synchronized with the output timing of the fourth scan line SLA, which is not output, that is, before the output timing of the fifth scan line SL5 for selective driving. In other words, the start signal SVS may be applied only to the gate driver connected to the fifth scan line SL5, which was selected by the selection signal SLM during the first frame interval for normal driving.

At this time, modulated clock signals CLK1 and CLK2 may be applied during the second frame interval. In other words, during the second frame interval, clock signals may not be applied to non-selected regions, and clock signals CLK1 and CLK2 may be applied only to the selected regions. These clock signals CLK1 and CLK2 may be modulated and applied by the timing controller. Here, the clock signal not being applied means that the clock signal is applied at a low-level voltage.

The voltage charged in the first capacitor Ca turns on the second transistor T2, and the high-level voltage of the start signal SVS turns on the third transistor T3, allowing the high-level voltage of the start signal to pre-charge the first control node Q(n).

At this time, since the selection signal SLM and the reset signal SRS are at a low-level voltage, the first transistor T1 and the fourth transistor T4 remain in the off state.

In the embodiment, the voltage charged in the first capacitor of the selection circuit is applied to the first control node Q(n) of the output circuit to pre-charge the first control node Q(n).

Therefore, after the second period P2, scan signals may be sequentially output from the output circuits connected to the fifth to eighth scan lines SL5 to SL8 by the pre-charged first control node Q(n).

Referring to FIGS. 8, 9, and 10C, during the third period P3 of the second frame interval for selective driving, a reset signal SRS with a high-level voltage may be applied to the gate driver connected to the fifth to eighth scan lines SL5 to SL8 after the output timing of the fifth to eighth scan lines, that is, at the output timing of the non-selected ninth scan line SL9.

By the high-level voltage of the reset signal SRS, the fourth transistor T4 is turned on, discharging the first control node Q(n) down to the low-potential voltage VSS, thereby blocking the gate-on voltage output of the scan signal.

At this time, since the selection signal SLM and the start signal SVS are at a low-level voltage, the first transistor T1, the second transistor T2, and the fourth transistor T4 remain in the off state.

Referring to FIGS. 8, 9, and 10C, during the fourth period P4, which is the vertical blanking interval of the second frame interval for selective driving, a selection signal SLM with a high-level voltage may be applied to the gate drivers connected to the first to twelfth scan lines SL1 to SL12.

By the high-level voltage of the selection signal SLM, the first transistor T1 is turned on, allowing the first capacitor Ca to discharge due to the low-level voltage of the scan signal.

At this time, the second transistor T2, the third transistor T3, and the fourth transistor T4 remain in the off state.

FIG. 11 is a diagram for explaining the modulation principle of the clock signal illustrated in FIG. 9.

Referring to FIG. 11, in the embodiment of the present disclosure, clock signals may be generated using a timing controller T-CON and a level shifter LS. That is, the timing controller T-CON generates a start signal VST′ and clock signals CLK1′ and CLK2′ at a first voltage level and applies them to the level shifter LS. The level shifter LS may generate a start signal VST and clock signals CLK1 and CLK2 at a second voltage level from the start signal VST′ and clock signals CLK1′ and CLK2′ at a first voltage level and apply them to the gate driver within the display panel.

At this time, the timing controller T-CON may analyze the image data to calculate the selected region and modulate the clock signals at the first voltage level VCC according to the calculated selected region. For example, in the selected region within the second frame interval of FIG. 9, the clock signal may be modulated so that pulses of the clock signal with a gate-on voltage level are generated, while in the non-selected region, clock signals with a gate-off voltage level are generated.

Here, the case where the clock signal is modulated by the timing controller T-CON is described as an example, but it is not necessarily limited thereto, and modulation may also be performed by the level shifter LS.

In the embodiment, only the selected region where the image is displayed is scanned, and the letterbox area of the screen, where no image is displayed, is not scanned. Here, the letterbox refers to the black bar region that appears at the top and bottom or the left and right of the screen during the process of adjusting the display to fit while maintaining the aspect ratio of the image.

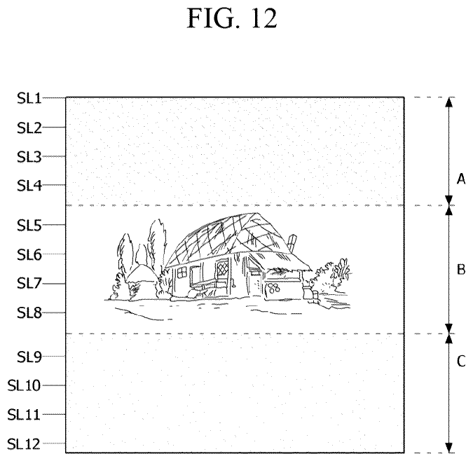

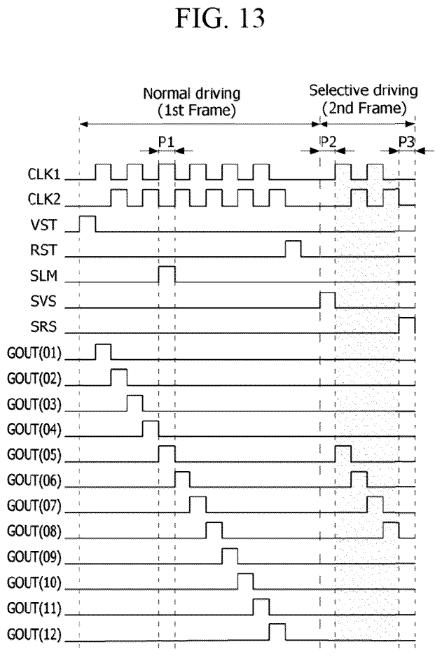

FIG. 12 is a diagram for explaining an example of scanning only selected regions where images are displayed, and FIG. 13 is a diagram showing a selective driving waveform of the gate driver illustrated in FIG. 12.

Referring to FIGS. 8, 12, and 13, during the first period P1 of the first frame interval for normal driving, a selection signal SLM with a high-level voltage may be applied to the gate driver connected to the fifth scan line SL5, which is the first scan line among the fifth to eighth scan lines SL5 to SL8 for selective driving.

By the high-level voltage of the selection signal SLM, the first transistor T1 is turned on, allowing the high-level voltage of the scan signal to be applied to the first node Na, thereby charging the first capacitor Ca.

During the second period P2 of the second frame interval for selective driving, a start signal SVS with a high-level voltage may be applied to the gate driver connected to the fifth scan line SL5, synchronized with the output timing of the fourth scan line SL4, which is not output, that is, before the output timing of the fifth scan line SL5 for selective driving. In other words, the start signal SVS may be applied only to the gate driver connected to the fifth scan line SL5, which was selected by the selection signal SLM during the first frame interval for normal driving.

The voltage charged in the first capacitor Ca turns on the second transistor T2, and the high-level voltage of the start signal SVS turns on the third transistor T3, allowing the high-level voltage of the start signal to pre-charge the first control node Q(n).

At this time, modulated clock signals CLK1 and CLK2 may be applied during the second frame interval. That is, in the second frame interval, clock signals CLK1 and CLK2 may be applied only to the scan lines of the selected region, as well as to one scan line before and one scan line after the selected region.

These clock signals CLK1 and CLK2 may be modulated and applied by the timing controller. For example, the timing controller may modulate 12 clock signals, which are to be applied to the first to twelfth scan lines, into 6 clock signals applied to the fourth to ninth scan lines.

During the third period P3 of the second frame interval for selective driving, a reset signal SRS with a high-level voltage may be applied to the gate driver connected to the fifth to eighth scan lines SL5 to SL8, at the output timing of the non-selected ninth scan line SL9, that is, after the output timing of the fifth to eighth scan lines SL5 to SL8.

By the high-level voltage of the reset signal SRS, the fourth transistor T4 is turned on, discharging the first control node Q(n) down to the low-potential voltage VSS, thereby blocking the gate-on voltage output of the scan signal.

In this embodiment, only a part of the entire screen, that is, the selected region where the image is displayed and a part of the non-selected region adjacent to the selected region, may be scanned.

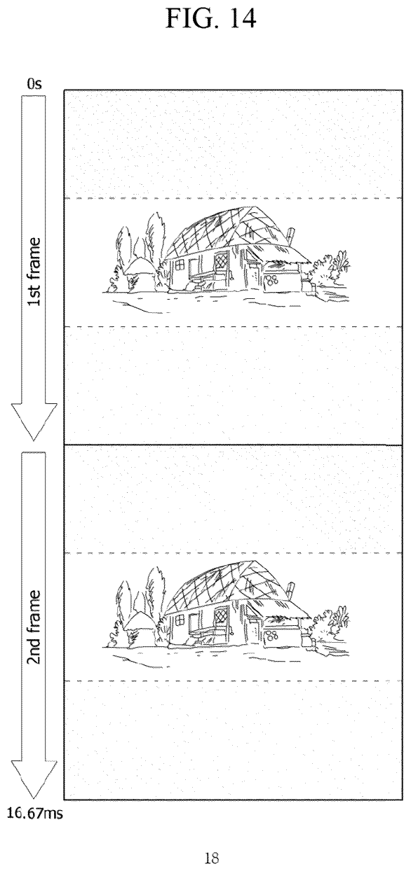

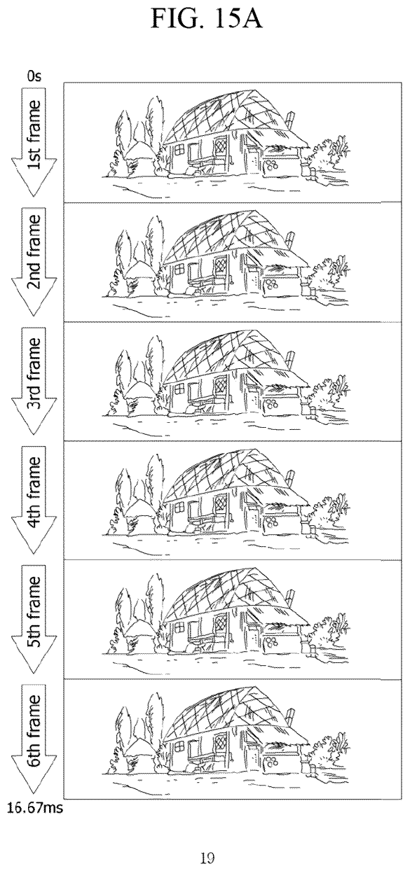

FIGS. 14 to 16 are diagrams for explaining the principle of improving the refresh rate.

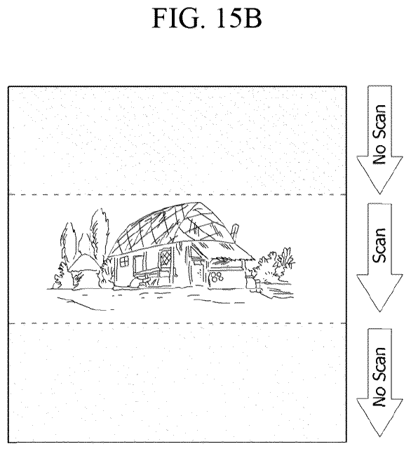

Referring to FIGS. 14 to 16, the refresh rates of the comparative example and the embodiment are shown. In the comparative example of FIG. 14, both the selected region where the image is displayed and the letterbox area where no image is displayed must be scanned in each frame. However, in the embodiment of FIGS. 15A and 15B, only the selected region where the image is displayed may be scanned in each frame.

For example, during 16.67 ms, while two frames are scanned in the comparative example, six frames including only the selected region are scanned in the embodiment, resulting in an approximately threefold increase in the refresh rate.

At this time, the refresh rate may vary depending on the size of the letterbox area within the screen. For example, as the size of the letterbox area increases, the refresh rate increases relatively more, whereas as the size of the letterbox area decreases, the refresh rate increases relatively less.

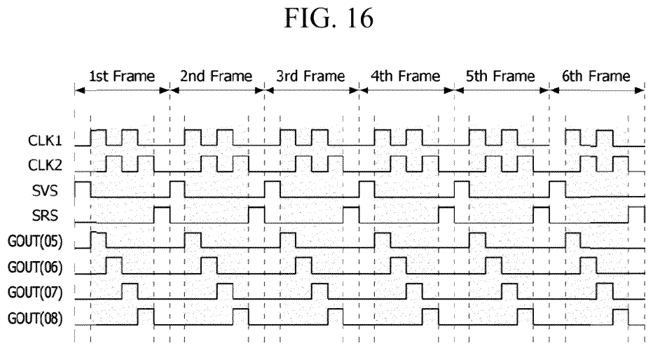

Accordingly, in the embodiment, as shown in FIG. 16, only six clock signals to be applied to the fourth to ninth scan lines among the first to twelfth scan lines may be generated in each frame, and the gate-on voltage of the scan signal may be output only from the gate driver connected to the fifth to eighth scan lines.

Therefore, since only six clock signals are generated for every six frames and only the region connected to the six scan lines is scanned, the refresh rate may be improved accordingly.

In one or more examples, a low-potential voltage may refer to VSS, and a high-potential voltage may refer to VDD. In one or more examples, a high-level voltage is higher than a low-level voltage.

Although the embodiments of the present disclosure have been described in more detail with reference to the accompanying drawings, the present disclosure is not limited thereto and may be embodied in many different forms without departing from the technical concept and scope of the present disclosure. Therefore, the embodiments disclosed in the present disclosure are provided for illustrative purposes only and are not intended to limit the technical concept and scope of the present disclosure. The technical concept and scope of the present disclosure are not limited thereto. Therefore, it should be understood that the above-described embodiments are illustrative in all aspects and do not limit the present disclosure. The scope of protection of the present disclosure should be construed based on the following claims, and all technical features within the scope of equivalents thereof should be construed as being included within the scope of the present disclosure.

What is claimed is:

1. A gate driver, comprising:
a plurality of signal transmission circuits that are dependently connected via carry lines, wherein each of the plurality of signal transmission circuits is connected to a respective carry line to which a respective carry signal is applied from a respective previous signal transmission circuit, and wherein each of the plurality of signal transmission circuits is configured to output a respective gate signal in response to a respective clock signal;
wherein an (n)th signal transmission circuit, where n is a positive integer, includes:
an output circuit configured to receive an (n−1)th carry signal from a previous signal transmission circuit, an (n+1)th carry signal from a next signal transmission circuit, and a clock signal, and to charge or discharge a first control node and a second control node to output a gate signal; and
a selection circuit configured to selectively charge the first control node so that the gate signal is output from the output circuit connected to a predetermined gate line among predetermined gate lines.

2. The gate driver according to claim 1, wherein:
the selection circuit includes a first transistor, a second transistor, a third transistor, and a fourth transistor;
the first transistor includes a gate electrode to which a selection signal is applied, a first electrode to which the gate signal is applied, and a second electrode connected to a first node;
the second transistor includes a gate electrode connected to the first node, a first electrode to which a start signal is applied, and a second electrode connected to a second node;
the third transistor includes a gate electrode to which the start signal is applied, a first electrode connected to the second node, and a second electrode connected to the first control node; and
the fourth transistor includes a gate electrode to which a reset signal is applied, a first electrode connected to the first control node, and a second electrode to which a low-potential voltage is applied.

3. The gate driver according to claim 2, further comprising:
a capacitor connected between the gate electrode and the second electrode of the second transistor.

4. The gate driver according to claim 3, wherein:
the selection signal is applied when the gate signal is output from the output circuit connected to a first gate line among the predetermined gate lines in a previous frame interval; and
the first transistor is turned on by the applied selection signal and applies a high-level voltage of the gate signal to the capacitor for charging.

5. The gate driver according to claim 3, wherein:
the start signal is applied before the gate signal is output from the output circuit connected to a first gate line among the predetermined gate lines in a current frame interval; and
the third transistor is turned on by the applied start signal and applies a high-level voltage of the start signal to the first control node for pre-charging.

6. The gate driver according to claim 3, wherein:
the reset signal is applied after the gate signal is output from the output circuit connected to a last gate line among the predetermined gate lines in a current frame interval; and
the fourth transistor is turned on by the applied reset signal and discharges the first control node down to the low-potential voltage.

7. The gate driver according to claim 3, wherein:
the selection signal is applied during a vertical blanking period of a current frame interval; and
the first transistor is turned on by the applied selection signal and discharges the capacitor to a low-level voltage of the gate signal.

8. The gate driver according to claim 1, wherein the clock signal is modulated to be applied in synchronization when the gate signal is output from the output circuit connected to the predetermined gate line in a current frame interval.

9. The gate driver according to claim 1, wherein:
the output circuit comprises a fifth transistor, a sixth transistor, a seventh transistor, an eighth transistor, a ninth transistor, a tenth transistor, and an eleventh transistor;
the fifth transistor comprises a gate electrode and a first electrode to which the (n−1)th carry signal is applied, and a second electrode connected to the first control node;
the sixth transistor comprises a gate electrode to which the (n+1)th carry signal is applied, a first electrode connected to the first control node, and a second electrode to which a low-potential voltage is applied;
the seventh transistor comprises a gate electrode connected to the second control node, a first electrode connected to the first control node, and a second electrode to which the low-potential voltage is applied;
the eighth transistor comprises a gate electrode and a first electrode to which a high-potential voltage is applied, and a second electrode connected to the second control node;
the ninth transistor comprises a gate electrode connected to the first control node, a first electrode connected to the second control node, and a second electrode to which the low-potential voltage is applied;
the tenth transistor comprises a gate electrode connected to the first control node, a first electrode to which the clock signal is applied, and a second electrode connected to an output node where the gate signal is output; and
the eleventh transistor comprises a gate electrode connected to the second control node, a first electrode connected to the output node, and a second electrode to which the low-potential voltage is applied.

10. A display device, comprising:
a pixel array in which a plurality of data lines, a plurality of gate lines, and a plurality of pixel circuits are arranged;
a data driver configured to output data voltages to the plurality of data lines;
a gate driver configured to output gate signals to the plurality of gate lines; and
a timing controller configured to control a timing operation of the data driver and the gate driver,
wherein the gate driver comprises:
a plurality of signal transmission circuits that are dependently connected via carry lines, wherein each of the plurality of signal transmission circuits is connected to a respective carry line to which a respective carry signal is applied from a respective previous signal transmission circuit, and wherein each of the plurality of signal transmission circuits is configured to output a respective gate signal in response to a respective clock signal; and
wherein an (n)th signal transmission circuit, where n is a positive integer, includes:
an output circuit configured to receive an (n−1)th carry signal from a previous signal transmission circuit, an (n+1)th carry signal from a next signal transmission circuit, and a clock signal, and to charge or discharge a first control node and a second control node to output a gate signal; and
a selection circuit configured to selectively charge the first control node so that the gate signal is output from the output circuit connected to a predetermined gate line among predetermined gate lines.

11. The display device according to claim 10, wherein:
the selection circuit comprises a first transistor, a second transistor, a third transistor, and a fourth transistor;
the first transistor comprises a gate electrode to which a selection signal is applied, a first electrode to which the gate signal is applied, and a second electrode connected to a first node;
the second transistor comprises a gate electrode connected to the first node, a first electrode to which a start signal is applied, and a second electrode connected to a second node;
the third transistor comprises a gate electrode to which the start signal is applied, a first electrode connected to the second node, and a second electrode connected to the first control node; and
the fourth transistor comprises a gate electrode to which a reset signal is applied, a first electrode connected to the first control node, and a second electrode to which a low-potential voltage is applied.

12. The display device according to claim 11, further comprising:
a capacitor connected between the gate electrode and the second electrode of the second transistor.

13. The display device according to claim 11, wherein the timing controller is configured to generate the selection signal, the start signal, the reset signal, and the clock signal so that the gate signal is selectively output from the output circuit connected to the predetermined gate line according to a pattern of an input image.

14. The display device according to claim 12, wherein:
the selection signal is applied when the gate signal is output from the output circuit connected to a first gate line among the predetermined gate lines in a previous frame interval; and
the first transistor is turned on by the applied selection signal and applies a high-level voltage of the gate signal to the capacitor for charging.

15. The display device according to claim 13, wherein:
the start signal is applied before the gate signal is output from the output circuit connected to a first gate line among the predetermined gate lines in a current frame interval; and
the third transistor is turned on by the applied start signal and applies a high-level voltage of the start signal to the first control node for pre-charging.

16. The display device according to claim 15, wherein:
the reset signal is applied after the gate signal is output from the output circuit connected to a last gate line among the predetermined gate lines in a current frame interval, and
the fourth transistor is turned on by the applied reset signal and discharges the first control node down to the low-potential voltage.

17. The display device according to claim 16, wherein the timing controller is configured to generate the clock signal to be applied to the predetermined gate line, one gate line disposed before the predetermined gate line, and one gate line disposed after the predetermined gate line.

18. The display device according to claim 12, wherein:
the selection signal is applied during a vertical blanking period of a current frame interval; and
the first transistor is turned on by the applied selection signal and discharges the capacitor to a low-level voltage of the gate signal.

19. The display device according to claim 10, wherein the clock signal is modulated to be applied in synchronization when the gate signal is output from the output circuit connected to the predetermined gate line in a current frame interval.

20. The display device according to claim 10, wherein:
the output circuit comprises a fifth transistor, a sixth transistor, a seventh transistor, an eighth transistor, a ninth transistor, a tenth transistor, and an eleventh transistor;
the fifth transistor comprises a gate electrode and a first electrode to which the (n−1)th carry signal is applied, and a second electrode connected to the first control node;
the sixth transistor comprises a gate electrode to which the (n+1)th carry signal is applied, a first electrode connected to the first control node, and a second electrode to which a low-potential voltage is applied;
the seventh transistor comprises a gate electrode connected to the second control node, a first electrode connected to the first control node, and a second electrode to which the low-potential voltage is applied;
the eighth transistor comprises a gate electrode and a first electrode to which a high-potential voltage is applied, and a second electrode connected to the second control node;
the ninth transistor comprises a gate electrode connected to the first control node, a first electrode connected to the second control node, and a second electrode to which the low-potential voltage is applied;
the tenth transistor comprises a gate electrode connected to the first control node, a first electrode to which the clock signal is applied, and a second electrode connected to an output node where the gate signal is output; and
the eleventh transistor comprises a gate electrode connected to the second control node, a first electrode connected to the output node, and a second electrode to which the low-potential voltage is applied.
